(19) United States
(12) Patent Application Publication
(10) Pub. No.: US 2023/0280938 A1
(43) Pub. Date: Sep. 7, 2023

(54) STORAGE APPARATUS AND CONTROL METHOD

(71) Applicant: Fujitsu Limited, Kawasaki-shi (JP)

(72) Inventors: Shoji OSHIMA, Kawasaki (JP); Atsuhiro OTAKA, Kawasaki (JP); Hidetoshi SATOU, Kawasaki (JP)

(73) Assignee: Fujitsu Limited, Kawasaki-shi (JP)

(21) Appl. No.: 18/068,891

(22) Filed: Dec. 20, 2022

(30) Foreign Application Priority Data
Mar. 1, 2022 (JP) 2022-030647

(51) Int. Cl. G06F 3/06

(52) U.S. Cl. CPC G06F 3/0658; G06F 3/0622; G06F 3/067

(57) ABSTRACT

A storage apparatus comprises a controller. Another storage apparatus including a first communication port is coupled to a network, and a first identification number with which a server accesses a first storage area is set in the first communication port. A second communication port in the storage apparatus is closed when the storage apparatus is in a standby state. The controller controls access to the second storage area by opening the second communication port in a case where an operation of the other storage apparatus stops and the storage apparatus transitions to the active state, using the first identification number, and execute diagnosis of the second communication port by changing the first identification number to a second identification number and opening the second communication port in a case where the diagnosis is executed when the storage apparatus is in the standby state.

### CROSS-REFERENCE TO RELATED APPLICATION

This application is based upon and claims the benefit of priority of the prior Japanese Patent Application No. 2022-30647, filed on Mar. 1, 2022, the entire contents of which are incorporated herein by reference.

### FIELD

The embodiments discussed herein are related to a storage apparatus and a control method.

### BACKGROUND

By making storage apparatuses redundant and enabling a failover, high availability for data access may be implemented. For example, when a first storage apparatus is in an active state and a second storage apparatus is in a standby state, the first storage apparatus receives an access request from a server and controls access to a first storage area. Data written to the first storage area is transferred to the second storage apparatus and is also written to a second storage area. When the operation of the first storage apparatus stops, the second storage apparatus transitions to the active state. Thereafter, the second storage apparatus receives an access request from the server and controls access to the second storage area.

As for diagnosis of an apparatus in a redundantly configured system, a diagnosis control system below has been proposed. In this diagnosis control system, when a standby-system apparatus is in a standby state, a diagnosis procedure of the standby-system apparatus is executed. In a case where information on switching from “standby” to “active” is written to a storage area of the standby-system apparatus by an active-system apparatus, the standby-system apparatus detects this information and interrupts the diagnosis procedure, so that the standby-system apparatus is caused to return to the standby state.

A technique related to a failover of storage apparatuses below has been also proposed. According to this technique, when a failure occurs in a virtual machine of a primary site, an instruction to switch to an official failover is transmitted to a virtual machine of a secondary site where a test failover is being executed, and a resumption preparation command for remote copy is transmitted to a storage apparatus of a standby system.

Japanese Laid-open Patent Publication No. 2008-217108 and International Publication Pamphlet No. WO 2018/011882 are disclosed as related art.

### SUMMARY

According to an aspect of the embodiments, a storage apparatus including a controller, wherein another storage apparatus including a first communication port is coupled to a network, a first identification number with which a server accesses a first storage area via the first communication port is assigned to the first communication port, and the other storage apparatus in an active state controls access to the first storage area in response to an access request received from the server via the first communication port, the controller includes a processor that is configured to: in a standby state, close a second communication port in the storage apparatus, and assign the first identification number to the second communication port as an identification number with which the server accesses, via the second communication port, a second storage area in which data is synchronized with data in the first storage area, in a case where an operation of the other storage apparatus stops and the storage apparatus transitions to the active state, control access to the second storage area by opening the second communication port and receiving the access request from the server via the second communication port, and in a case where the diagnosis is executed when the storage apparatus is in the standby state, execute diagnosis of the second communication port by changing the first identification number assigned to the second communication port to a second identification number and opening the second communication port.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating examples of a configuration and processing of a storage system according to a first embodiment;

FIG. 2 is a diagram illustrating an example of a configuration of a storage system according to a second embodiment;

FIG. 3 is a diagram illustrating an example of a hardware configuration of controller modules (CMs) and drive units;

FIG. 4 is a diagram for describing access paths between the CMs and a business server;

FIG. 5 is a diagram for describing a failover operation;

FIG. 6 is a diagram illustrating an example of a configuration of processing functions included in the CMs and a monitoring server;

FIG. 7 is an example of a flowchart (part 1) illustrating a procedure of port diagnosis processing;

FIG. 8 is an example of a flowchart (part 2) illustrating the procedure of the port diagnosis processing;

FIG. 9 is an example of a flowchart (part 3) illustrating the procedure of the port diagnosis processing;

FIG. 10 is a diagram for describing a first example of diagnosis response data;

FIG. 11 is a diagram for describing a second example of the diagnosis response data;

FIG. 12 is an example of a flowchart illustrating a procedure of logical unit (LU) information acquisition command reception processing; and

FIG. 13 is an example of a flowchart illustrating a procedure of failover processing.

### DESCRIPTION OF EMBODIMENTS

In a storage system including the first and second storage apparatuses described above, an automatic failover is implemented by a method below, for example. The server is set to be able to access a storage area via a communication port to which a specific identification number is assigned. The specific identification number described above is assigned in communication ports of both the first and second storage apparatuses.

When the first storage apparatus is in the active state, the communication port of the second storage apparatus that is in the standby state is in a closed state. In this state, the server is able to access the first storage area via the communication port of the first storage apparatus. From this state, when the operation of the first storage apparatus stops and the second storage apparatus transitions to the active state, the communication port of the second storage apparatus is opened and linked up. In this state, the server is able to access the second storage area via the communication port of the second storage apparatus. Such control allows the server to continue the access to the storage area without particularly recognizing the occurrence of the failover.

For example, in a case where such control is performed, even if the communication port of the second storage apparatus in the standby state becomes inoperable due to a failure or the like, since this communication port is in the closed state, the second storage apparatus is unable to detect that the communication port is inoperable. Such a trouble is detected for the first time because the communication port does not link up when the second storage apparatus transitions to the active state due to the failover. In this case, the failover is not successfully performed, and access processing from the server to the storage area stops. Accordingly, it is desirable to be able to diagnose whether the communication port on the standby side is in a normally operable state during a period in which this communication port is not used for control of access to the storage area in response to a request from the server.

However, if the communication port of the second storage apparatus in the standby state is opened for diagnosis, this communication port is recognized by the server. Since two identical storage apparatuses having the storage area to be accessed appear to be present from the server, the server determines that an abnormality has occurred and is no longer able to normally continue the access to the storage area.

In one aspect, an object of the present disclosure is to provide a storage apparatus and a control method capable of diagnosing a communication port in a standby state.

Embodiments of the present disclosure will be described below with reference to the drawings.

### First Embodiment

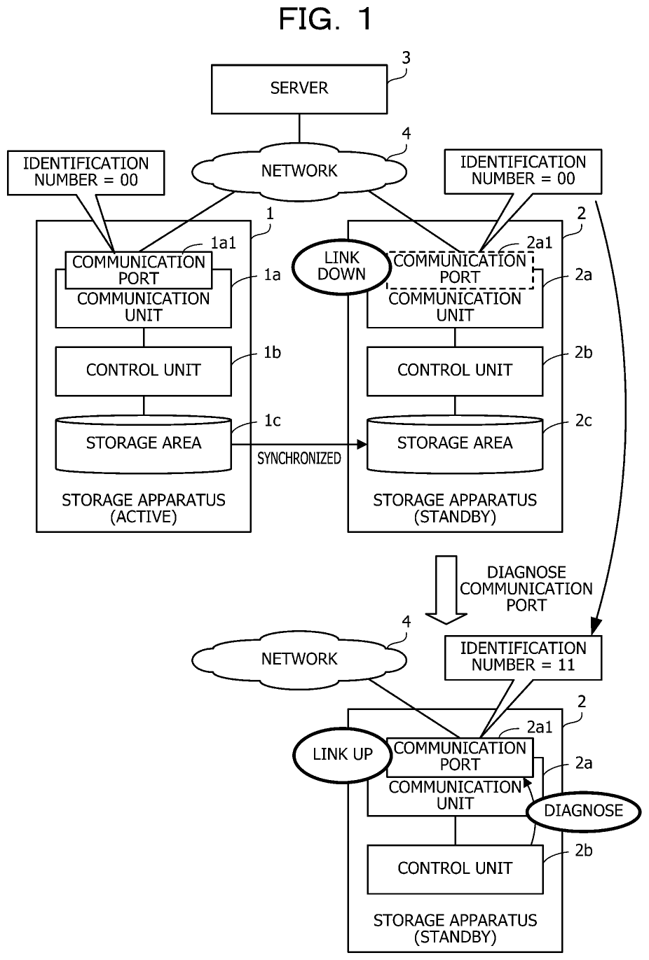

FIG. 1 is a diagram illustrating examples of a configuration and processing of a storage system according to a first embodiment. The storage system illustrated in FIG. 1 includes storage apparatuses 1 and 2 and a server 3. The storage apparatuses 1 and 2 and the server 3 are coupled to each other via a network 4.

The storage apparatus 1 includes a communication unit 1a and a control unit (or a controller) 1b. The communication unit 1a is a communication interface including a communication port 1a1 coupled to the network 4, and communicates with the server 3 via the communication port 1a1. The control unit 1b is, for example, a processor, and executes processing such as communication with the server 3 via the communication unit 1a and access control for a storage area 1c. The storage area 1c may be a storage area of a storage device mounted inside the storage apparatus 1 or a storage area of a storage device externally coupled to the storage apparatus 1.

Similarly to the storage apparatus 1, the storage apparatus 2 includes a communication unit 2a and a control unit 2b. The communication unit 2a is a communication interface including a communication port 2a1 coupled to the network 4, and communicates with the server 3 via the communication port 2a1. The control unit 2b is, for example, a processor, and executes processing such as communication with the server 3 via the communication unit 2a and access control for a storage area 2c. The storage area 2c may be a storage area of a storage device mounted inside the storage apparatus 2 or a storage area of a storage device externally coupled to the storage apparatus 2.

The server 3 is a server computer that accesses each of the storage areas 1c and 2c by transmitting an access request to the storage apparatuses 1 and 2.

One of the storage apparatuses 1 and 2 described above operates in an active state (operating state), and the other operates in a standby state. In the storage apparatus in the active state, the control unit controls access to the storage area corresponding to this control unit in response to an access request from the server 3. In a case where the operation of the storage apparatus in the active state stops, the storage apparatus in the standby state transitions to the active state, and this storage apparatus takes over the control of the access to the storage area in response to an access request from the server 3 (failover).

The server 3 is set to be able to access the storage areas 1c and 2c via a communication port to which a specific identification number is assigned. For example, a logical storage area recognized by the server 3 is set with the storage area 1c or the storage area 2c, and the server 3 is set to be able to access this logical storage area via the communication port to which the specific identification number is assigned. In FIG. 1, this identification number is assumed to be “00” as an example.

As illustrated on the upper side in FIG. 1, in a case where the storage apparatus 1 is in the active state and the storage apparatus 2 is in the standby state, the aforementioned identification number “00” is set for both of the communication ports 1a1 and 2a1. The communication port 1a1 is opened in the storage apparatus 1 in the active state, whereas the communication port 2a1 is closed in the storage apparatus 2 in the standby state. Since the server 3 is in a state in which the server 3 is able recognize only the communication port 1a1, the server 3 is automatically coupled to the communication port 1a1 by designating the identification number “00”, and may access the storage area 1c by transmitting an access request to the communication port 1a1. In this state, data written to the storage area 1c is also written to the storage area 2c, and the data is synchronized between the storage areas 1c and 2c.

Next, it is assumed that, from this state, the operation of the storage apparatus 1 stops and the storage apparatus 2 transitions to the active state. In this case, the control unit 2b of the storage apparatus 2 opens the communication port 2a1. At this time, since the server 3 becomes able to recognize the communication port 2a1 instead of the communication port 1a1, the server 3 is automatically coupled to the communication port 2a1 by designating the identification number “00”, and transmits an access request to the communication port 2a1. The control unit 2b controls access to the storage area 2c in response to the access request received via the communication port 2a1. In this manner, the server 3 may continue the access to the storage area without particularly recognizing the occurrence of the failover.

As described above, when the storage apparatus 2 is in the standby state, the communication port 2a1 is closed. For this reason, even if the communication port 2a1 fails or a communication cable coupled to the communication port 2a1 becomes unable to communicate when the storage apparatus 2 is in the standby state, the storage apparatus 2 is unable to detect the failure or the communication inability. Such a trouble is detected for the first time because the communication port 2a1 does not link up when the storage apparatus 2 transitions to the active state due to the failover. In this case, the failover is not successfully performed, and the access control for the storage area in response to a request from the server 3 stops. Accordingly, it is desirable to be able to diagnose whether the communication port on the standby side is in a normally operable state during a period in which this communication port is not used for access control for the storage area in response to a request from the server 3.

However, if the communication port 2a1 is opened for diagnosis when the storage apparatus 2 is in the standby state, the communication port 2a1 is recognized by the server 3. Since two identical storage apparatuses having the storage area to be accessed appear to be present from the server 3, the server 3 determines that an abnormality has occurred and is no longer able to normally continue the access to the storage area.

Against such an issue, when the storage apparatus 2 is in the standby state, the control unit 2b executes diagnosis of the communication port 2a1 in a following procedure. As illustrated on the lower side in FIG. 1, the control unit 2b first changes the identification number assigned for the communication port 2a1 from the identification number “00” to a different identification number (“11” herein). In a state in which the setting value of the identification number is changed in this manner, the control unit 2b opens the communication port 2a1 and executes processing of diagnosing whether the communication port 2a1 operates normally.

As the different identification number set at the time of the diagnosis, any identification number different from the identification number “00” may be set. However, to avoid an overlap of the identification number between the communication ports coupled to the network 4, it is desirable that a value that is not set for any communication port coupled to the network 4 is assigned as the different identification number.

By the processing described above, even if the communication port 2a1 is opened for the diagnosis, the server 3 does not recognize this communication port 2a1 as a communication port for accessing the storage area 2c. Thus, the server 3 may continue the access to the storage area 1c via the communication port 1a1 of the storage apparatus 1 without particularly detecting the occurrence of an abnormality. Accordingly, the storage apparatus 2 in the standby state may diagnose the communication port thereof without the server 3 detecting an abnormality.

### Second Embodiment

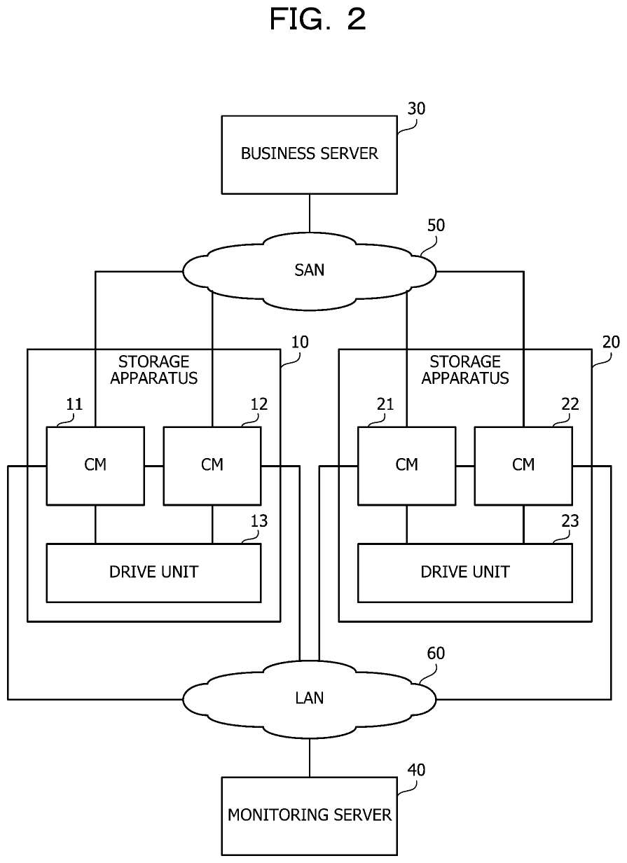

FIG. 2 is a diagram illustrating an example of a configuration of a storage system according to a second embodiment. The storage system illustrated in FIG. 2 includes storage apparatuses 10 and 20, a business server 30, and a monitoring server 40. The storage apparatuses 10 and 20 are an example of the storage apparatuses 1 and 2 illustrated in FIG. 1, and the business server 30 is an example of the server 3 illustrated in FIG. 1.

The storage apparatus 10 includes controller modules (CMs) 11 and 12 and a drive unit 13. The CMs 11 and 12 are coupled to the business server 30 via a storage area network (SAN) 50. The CMs 11 and 12 are storage control devices that control input and output (I/O) processing for storage devices mounted in the drive unit 13 in response to an I/O request from the business server 30. A plurality of nonvolatile storage devices such as hard disk drives (HDDs) or solid-state drives (SSDs) are mounted in the drive unit 13.

A hardware configuration of the storage apparatus 20 is substantially the same as that of the storage apparatus 10. For example, the storage apparatus 20 includes CMs 21 and 22 and a drive unit 23. The CMs 21 and 22 are coupled to the business server 30 via the SAN 50. The CMs 21 and 22 are storage control devices that control I/O processing for storage devices mounted in the drive unit 23. A plurality of nonvolatile storage devices such as HDDs or SSDs are mounted in the drive unit 23.

The CMs 11 and 12 set a logical storage area using the storage devices mounted in the drive unit 13 as a physical storage area, and receives an I/O request for the logical storage area from the business server 30. Likewise, the CMs 21 and 22 also set a logical storage area using the storage devices mounted in the drive unit 23 as a physical storage area, and receives an I/O request for the logical storage area from the business server 30. Hereinafter, such a logical storage area may be referred to as a “logical unit (LU)”. The storage devices mounted in the drive units 13 and 23 may be referred to as “disk drives”.

A pair of logical units (LU pair) to be synchronized between the CM included in the storage apparatus 10 and the CM included in the storage apparatus 20 may be set. Among the CMs for which the respective logical units included in the LU pair are set, one of the CMs operates as an active (operating-state) CM and the other operates as a standby (standby-state) CM. If the operation of the active CM stops due to a failure or the like, the other CM transitions from “standby” to “active” and takes over the processing (I/O control of the logical unit) performed by the CM that has been active until then (failover). In practice, “active” and “standby” may be switched in units of the storage apparatuses.

The CMs 11 and 12 and the CMs 21 and 22 may communicate with each other via the SAN 50. In a state in which both of the CMs for which the respective logical units included in the LU pair are set are normally operating, synchronous copy of the logical unit is executed from the active CM to the standby CM.

The business server 30 is a server computer that executes various kinds of business-related processing. When executing those kinds of processing, the business server 30 transmits an I/O request for the logical unit to the active CM among the CMs 11, 12, 21, and 22.

The monitoring server 40 is coupled to the CMs 11, 12, 21, and 22 via a local area network (LAN) 60. The monitoring server 40 is a server computer that monitors operations of the CMs 11, 12, 21, and 22. For example, the monitoring server 40 controls execution of a failover based on an operation monitoring result. For example, when an abnormality occurs in the operation of the active CM, the monitoring server 40 causes the corresponding standby CM to transition to “active”. The LAN 60 is an example of a network for monitoring the operations of the CMs 11, 12, 21, and 22.

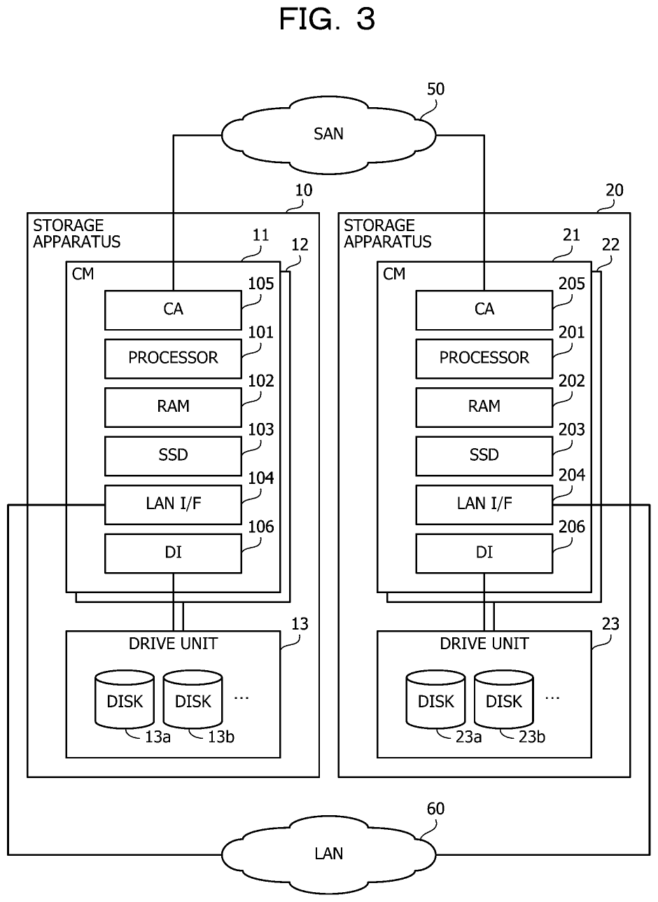

FIG. 3 is a diagram illustrating an example of a hardware configuration of the CMs and the drive units.

The CM 11 includes a processor 101, a random-access memory (RAM) 102, an SSD 103, a LAN interface (I/F) 104, a channel adapter (CA) 105, and a drive interface (DI) 106. The drive unit 13 includes disk drives 13a, 13b, and so on. In FIG. 3, the disk drive is denoted as “DISK”.

The processor 101 centrally controls the entire CM 11. The processor 101 may be, for example, any of a central processing unit (CPU), a microprocessor unit (MPU), a digital signal processor (DSP), an application-specific integrated circuit (ASIC), a graphics processing unit (GPU), or a programmable logic device (PLD). The processor 101 may be a combination of two or more elements among a CPU, an MPU, a DSP, an ASIC, a GPU, and a PLD.

The RAM 102 is a main storage device of the CM 11. The RAM 102 temporarily stores at least part of an operating system (OS) program and an application program that are executed by the processor 101. The RAM 102 stores various kinds of data used in processing performed the processor 101. The SSD 103 is an auxiliary storage device of the CM 11. The SSD 103 stores the OS program, the application program, and the various kinds of data. As the auxiliary storage device, the CM 11 may include an HDD instead of the SSD 103.

The LAN interface 104 is an interface for communicating with the monitoring server 40 via the LAN 60. The CA 105 is an interface for communicating with the business server 30 and the CMs 21 and 22 of the storage apparatus 20 via the SAN 50. In practice, the CM 11 separately includes a CA 105 for communicating with the business server 30 and a CA 105 for communicating with the CMs 21 and 22 of the storage apparatus 20. The DI 106 is an interface for communicating with the disk drives 13a, 13b, . . . in the drive unit 13.

The hardware configuration of the other CMs 12, 21, and 22 is substantially the same as that of the CM 11. For example, as illustrated in FIG. 3, the CM 21 includes a processor 201, a RAM 202, an SSD 203, a LAN I/F 204, a CA 205, and a DI 206. The drive unit 23 includes disk drives 23a, 23b, and so on.

Although not illustrated, each of the business server 30 and the monitoring server 40 may be implemented as a computer including a processor, a main storage device, an auxiliary storage device, a communication interface, and so on.

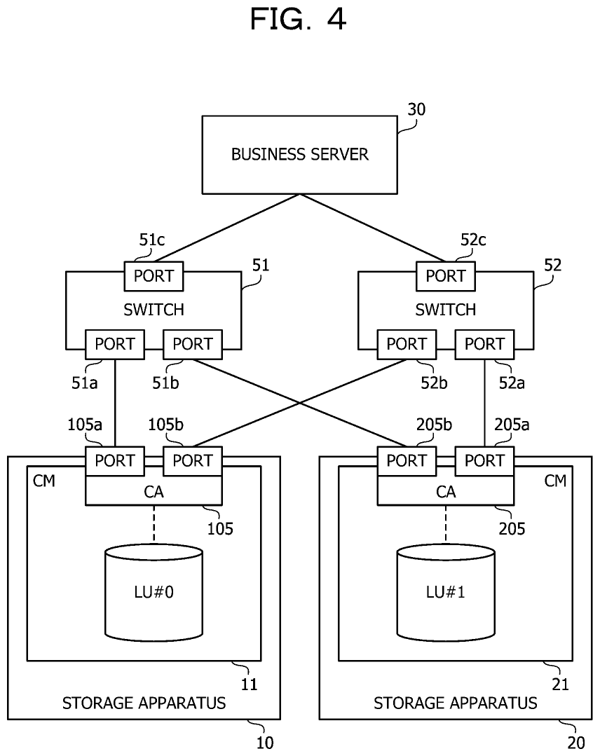

FIG. 4 is a diagram for describing access paths between the CMs and the business server.

In the present embodiment, as an example, it is assumed that the following logical units are set. A logical unit LU #0 implemented with the disk drives of the drive unit 13 is set in the CM 11 of the storage apparatus 10. The logical unit LU #0 is defined as a logical storage area accessible by the business server 30 via the CA 105 of the CM 11. A logical unit LU #1 implemented with the disk drives of the drive unit 23 is set in the CM 21 of the storage apparatus 20. The logical unit LU #1 is defined as a logical storage area accessible by the business server 30 via the CA 205 of the CM 21. The logical unit LU #0 and the logical unit LU #1 are set as an LU pair, and data is synchronized between these units.

Access paths from the business server 30 to the logical units LU #0 and LU #1 will be described next. As illustrated in FIG. 4, the business server 30 and the CMs 11 and 21 may communicate with each other via a switch 51 or a switch 52. The switch 51 includes ports 51a to 51c. The switch 52 includes ports 52a to 52c. The CA 105 of the CM 11 includes ports 105a and 105b. The CA 205 of the CM 21 includes ports 205a and 205b.

The port 51a of the switch 51 is coupled to the port 105a of the CA 105. The port 51b of the switch 51 is coupled to the port 205b of the CA 205. The port 52a of the switch 52 is coupled to the port 205a of the CA 205. The port 52b of the switch 52 is coupled to the port 105b of the CA 105. The port 51c of the switch 51 and the port 52c of the switch 52 are coupled to a communication port (not illustrated) of the business server 30.

As access paths from the business server 30 to the logical unit LU #0, there are a path passing through the ports 51c, 51a, and 105a and a path passing through the ports 52c, 52b, and 105b. As described above, the access paths to the logical unit LU #0 are made redundant. As access paths from the business server 30 to the logical unit LU #1, there are a path passing through the ports 52c, 52a, and 205a and a path passing through the ports 51c, 51b, and 205b. As described above, the access paths to the logical unit LU #1 are also made redundant.

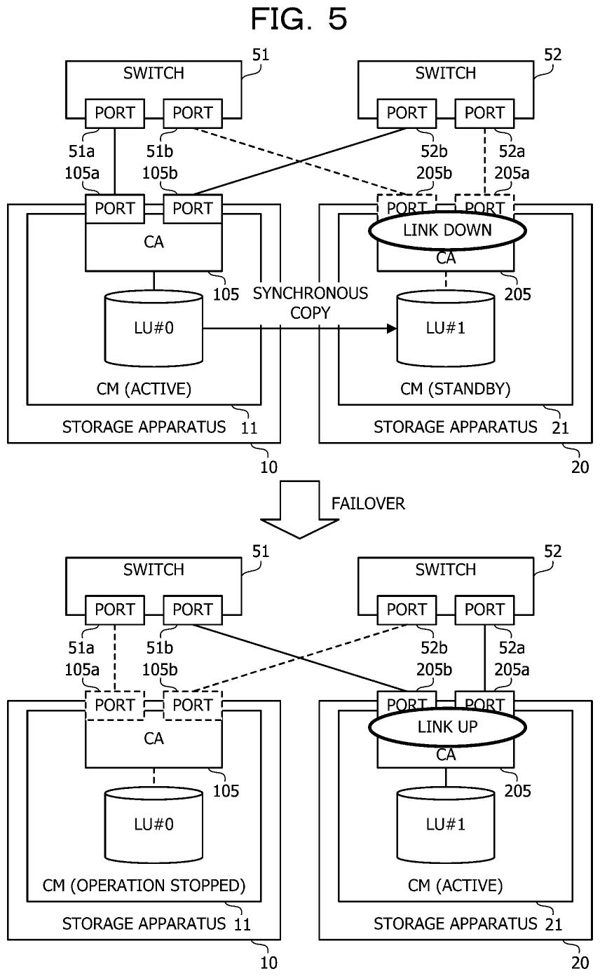

FIG. 5 is a diagram for describing a failover operation. The upper side in FIG. 5 illustrates a state in which the CM 11 in which the logical unit LU #0 is set is active and the CM 21 in which the logical unit LU #1 is set is standby. In this state, the business server 30 accesses the logical unit LU #0 via the CA 105 of the CM 11. Data written to the logical unit LU #0 from the business server 30 is transferred from the CM 11 to the CM 21 and written also to the logical unit LU #1, so that the data are kept equivalent between the logical units LU #0 and LU #1. For example, synchronous copy as described below is executed at the time of data writing. Upon receiving a write request to the logical unit LU #0 from the business server 30, the CM 11 writes the data subjected to the write request to the logical unit LU #0, transfers the data to the CM 21, and writes the data also to the logical unit LU #1. After the writing of the data to the logical units LU #0 and LU #1 is completed, the CM 11 makes a response indicating the completion of the writing to the business server 30.

The data written to the logical unit LU #0 and also written to the logical unit LU #1 is transferred via the SAN 50. Although not illustrated, the CMs 11 and 21 include other CAs different from the CAs for communicating with the business server 30, and data transfer between the CMs 11 and 21 is performed through these CAs.

For the LU pair including the logical units LU #0 and LU #1, the port setting is shared between the CA 105 and the CA 205. For example, port identification numbers used by the business server 30 to access the logical unit LU #0 are set for the respective ports 105a and 105b of the CA 105. For the ports 205a and 205b of the CA 205, the same port identification numbers as those of the ports 105a and 105b are set, respectively.

In the state illustrated on the upper side in FIG. 5, the ports 205a and 205b of the CA 205 are in a closed state, and the ports 105a and 105b of the CA 105 are in an open state. Thus, the business server 30 recognizes the ports 105a and 105b of the CA 105 as communication destinations, and accesses the logical unit LU #0 via the ports 105a and 105b of the CA 105.

If an abnormality occurs in the operation of the CM 11 and the ports 105a and 105b of the CA 105 are linked down, a failover is performed as illustrated on the lower side in FIG. 5. In response to a failover instruction from the monitoring server 40, the CM 21 opens the ports 205a and 205b of the CA 205 and transitions to an active state. Thus, the business server 30 recognizes the ports 205a and 205b of the CA 205 as the communication destinations.

As described above, the same port identification numbers as those of the ports 105a and 105b are assigned for the ports 205a and 205b of the CA 205, respectively. For this reason, the business server 30 recognizes the ports 205a and 205b of the CA 205 as the same ports as the ports 105a and 105b, respectively, and continues the communication. The business server 30 recognizes the logical unit LU #1 as the same storage area as the logical unit LU #0 and accesses the logical unit LU #1.

As described above, the same setting is applied to the ports of the CA 105 and the ports of the CA 205, only the ports of the active-side CA are opened, and the ports of the standby-side CA are opened at the time of a failover. Thus, at the time of a failover, the access paths to the logical unit are automatically switched without the business server 30 particularly recognizing the switching of the access destinations. The business server 30 may continue the access to the logical unit without particularly recognizing that the failover has been performed.

In a case where communication using a fibre channel (FC) is performed between the business server 30 and the CAs 105 and 205, for example, a world wide name (WWN) is set as the port identification number described above. In a case where communication using Internet Small Computer System Interface (iSCSI) is performed between the business server 30 and the CAs 105 and 205, for example, one or both of an iSCSI name and an iSCSI Internet Protocol (IP) address is/are set as the port identification number described above.

As described above, the ports of the standby-side CA are closed in a normal state. For this reason, even if this port or a communication cable coupled thereto fails in terms of hardware due to aged deterioration or the like and becomes inoperable, the standby CM is unable to detect the operation inability. Such a trouble is detected for the first time because the port does not link up when the standby-side CA transitions to the active state due to the failover. In this case, the failover is not successfully performed, and the I/O processing for the logical unit stops. Accordingly, it is desirable to be able to diagnose whether the port of the standby-side CA is in a normally operable state during a period in which the port is in a sleep state.

However, for example, if the port of the standby-side CA is opened to diagnose the state of the port, the business server 30 recognizes the port. At this time, since two identical apparatuses appear to be present as access destinations for accessing the logical unit from the business server 30, the business server 30 determines that an abnormality has occurred and is no longer to be able to normally continue the communication. When the logical unit of the standby CM is visible from the business server 30, unnecessary processing is executed in the business server 30. Thus, the business server 30 may become unable to perform communication or a processing load of the business server 30 may increase. Because the occurrence of such a situation is expected, there is an issue in that it is difficult to diagnose the state of the port of the standby-side CA.

Accordingly, the present embodiment enables the state of the port of the standby-side CA to be diagnosed while avoiding a situation in which the business server 30 recognizes this port and enters a state in which the business server 30 is able to access to the logical unit LU #1.

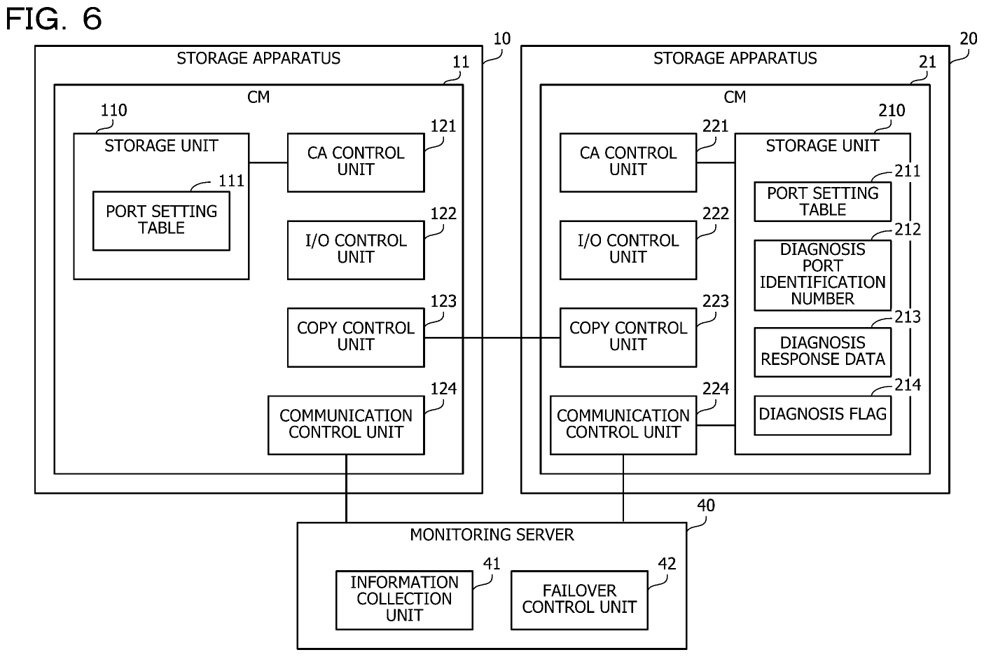

FIG. 6 is a diagram illustrating an example of a configuration of processing functions included in the CMs and the monitoring server. FIG. 6 illustrates, as the processing functions of the CM 11, only processing functions that operate when the CM 11 is active. On the other hand, FIG. 6 illustrates, as the processing functions of the CM 21, only processing functions that operate when the CM 21 transitions from “standby” to “active”. In practice, the CMs 11 and 21 have the same processing functions.

The CM 11 includes a storage unit 110. The storage unit 110 is a storage area of a storage device, such as the RAM 102 or the SSD 103, included in the CM 11. The storage unit 110 stores a port setting table 111. In the port setting table 111, port identification numbers assigned to the respective ports 105a and 105b of the CA 105 are set. In the CM 11, the set port identification numbers, the port identification number of the port of the business server 30, and the logical unit LU #0 accessible via the port are managed in association with one another.

The CM 11 further includes a CA control unit 121, an I/O control unit 122, a copy control unit 123, and a communication control unit 124. Processing of the CA control unit 121, the I/O control unit 122, the copy control unit 123, and the communication control unit 124 is implemented by the processor 101 of the CM 11 executing a predetermined program.

The CA control unit 121 controls data transmission and reception using the CA 105. For example, based on the port setting table 111, the CA control unit 121 opens the ports 105a and 105b of the CA 105 by using the port identification numbers respectively corresponding to the ports 105a and 105b.

In response to an I/O request from the business server 30, the I/O control unit 122 executes I/O processing for the logical unit LU #0. This I/O processing is executed in cooperation with the copy control unit 123.

The copy control unit 123 transfers, to the standby CM 21, data requested by the business server 30 to be written to the logical unit LU #0, and requests the standby CM 21 to write the data to the logical unit LU #1.

The communication control unit 124 controls data transmission and reception to and from the monitoring server 40 via the LAN 60.

The CM 21 includes a storage unit 210. The storage unit 210 is a storage area of a storage device, such as the RAM 202 or the SSD 203, included in the CM 21. The storage unit 210 stores a port setting table 211, a diagnosis port identification number 212, diagnosis response data 213, and a diagnosis flag 214.

In the port setting table 211, port identification numbers assigned to the respective ports 205a and 205b of the CA 205 are set. In a normal state in which the CM 11 is operating normally as being active, the same port identification number as that of the port 105a of the CA 105 is set for the port 205a and the same port identification number as that of the port 105b of the CA 105 is set for the port 205b. In the CM 21, the set port identification numbers, the port identification number of the port of the business server 30, and the logical unit LU #1 accessible via the port are managed in association with one another.

The diagnosis port identification number 212 is a port identification number that is temporarily set for the ports 205a and 205b of the CA 205 when the states of the ports 205a and 205b of the CA 205 are diagnosed. The diagnosis port identification number 212 may be individually prepared for each of the ports 205a and 205b. As the diagnosis port identification number 212, port identification numbers that are not used in communication by the ports of all devices coupled to the SAN 50 including the business server 30 are set in advance. For example, as the diagnosis port identification number 212, the port identification number set for each of the ports 205a and 205b at the time of factory shipment is set.

The diagnosis response data 213 is data used as response data in a case where a command for acquiring information on a logical unit is received from the business server 30 when the states of the ports 205a and 205b of the CA 205 are diagnosed.

The diagnosis flag 214 is flag information indicating whether or not the states of the ports 205a and 205b of the CA 205 are being diagnosed. In the present embodiment, the value of the diagnosis flag 214 is set to “1” in a state in which the diagnosis is being performed and is set to “0” in a state in which the diagnosis is not being performed.

The CM 21 further includes a CA control unit 221, an I/O control unit 222, a copy control unit 223, and a communication control unit 224. Processing of the CA control unit 221, the I/O control unit 222, the copy control unit 223, and the communication control unit 224 is implemented by the processor 201 of the CM 21 executing a predetermined program.

The CA control unit 221 controls data transmission and reception using the CA 205. For example, based on the port setting table 211, the CA control unit 221 opens the ports 205a and 205b of the CA 205 by using the port identification numbers respectively corresponding to the ports 205a and 205b. The CA control unit 221 controls execution of port diagnosis processing for diagnosing the states of the ports 205a and 205b of the CA 205.

When a failover occurs and the CM 21 transitions to “active”, the I/O control unit 222 executes I/O processing for the logical unit LU #1 in response to an I/O request from the business server 30.

When the CM 21 is standby, the copy control unit 223 writes, to the logical unit LU #1, the write data transferred from the copy control unit 123 of the CM 11.

The communication control unit 224 controls data transmission and reception to and from the monitoring server 40 via the LAN 60.

The monitoring server 40 includes an information collection unit 41 and a failover control unit 42. Processing of the information collection unit 41 and the failover control unit 42 is implemented by a processor (not illustrated) included in the monitoring server 40 executing a predetermined program.

The information collection unit 41 collects state information on an operation state from the storage apparatuses 10 and 20. As the state information, for example, a link-up state of the ports of the CA, success or failure of a synchronous copy operation between the logical units, alive confirmation information of the storage apparatuses, and the like are collected. The information collection unit 41 may transmit the collected state information to the CMs 11, 12, 21, and 22 in response to a request from the CMs 11, 12, 21, and 22.

Based on the state information collected by the information collection unit 41, the failover control unit 42 periodically determines whether an execution condition of a failover is satisfied. If determining that the execution condition is satisfied, the failover control unit 42 transmits a failover instruction to the standby CM and causes the standby CM to transition to “active”.

Processing performed in the standby CM 21 will be described next by using flowcharts.

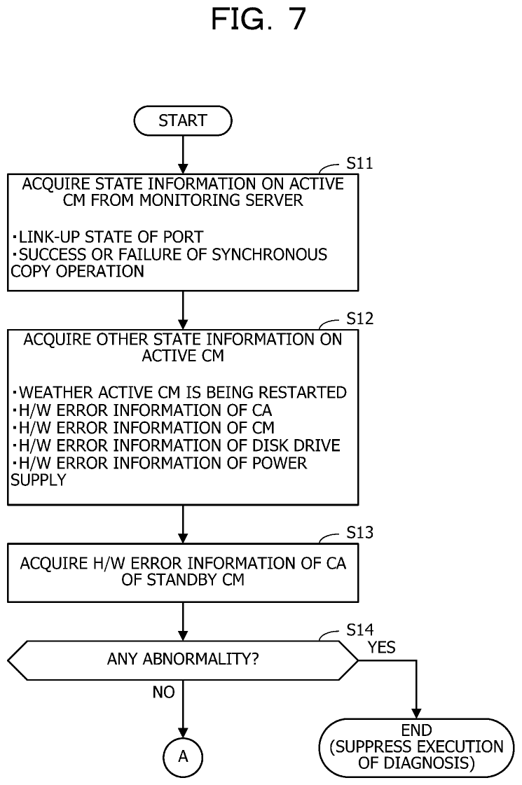

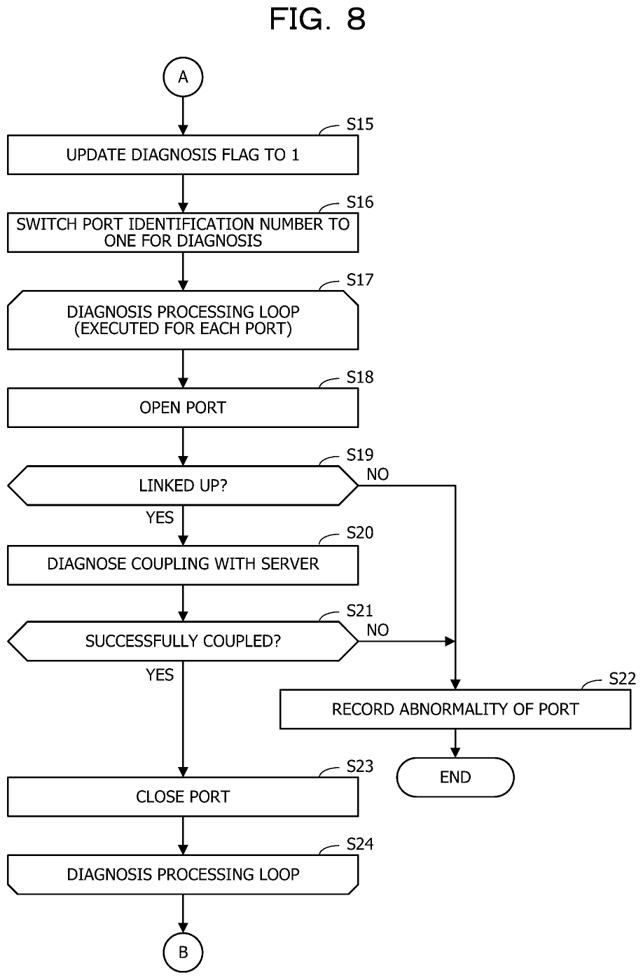

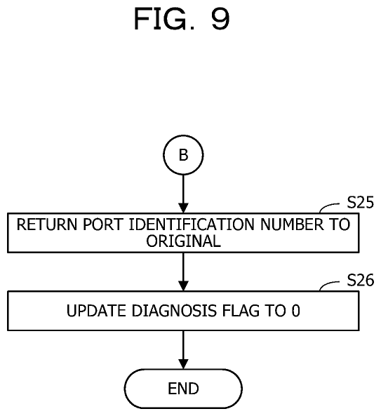

FIGS. 7 to 9 are examples of flowcharts illustrating a procedure of port diagnosis processing. First, it is determined whether the current state is a diagnosis executable state through preprocessing illustrated in FIG. 7, and in a case where it is determined that the current state is the diagnosis executable state, diagnosis processing illustrated in FIGS. 8 and 9 is executed.

[Step S11] The CA control unit 221 of the CM 21 acquires state information on the active CM 11 from the monitoring server 40 via the communication control unit 224. As the state information, for example, a link-up state indicating whether each port of the CA 105 of the CM 11 is linked up, information indicating whether the synchronous copy processing of the data in the logical unit by the CM 11 is normally executed, and the like are acquired. Such state information is periodically collected by the information collection unit 41 of the monitoring server 40, and the CM 21 is notified of the latest state information collected in response to a request from the CM 21 in step S11.

[Step S12] The CA control unit 221 acquires other state information on the active CM 11 from the CM 11. As the other state information, for example, information indicating whether the CM 11 is being restarted, information indicating the presence or absence of a hardware (H/W) error in the CA 105 of the CM 11, information indicating the presence or absence of an error in other hardware of the CM 11, information indicating the presence or absence of a hardware error in the disk drives coupled to the CM 11, information indicating the presence or absence of a hardware error in a power supply of the CM 11, and the like are acquired. For example, such state information is acquired directly from the CM 11 through the same communication path as that for the synchronous copy between the CM 11 and the CM 21.

[Step S13] The CA control unit 221 acquires information indicating the presence or absence of a hardware (H/W) error in the CA 205 included in the standby CM 21.

[Step S14] Based on the state information acquired in steps S11 and the state information acquired in step S12, the CA control unit 221 determines whether there is an abnormality in the CM 11. If it is determined that there is an abnormality, the port diagnosis processing is ended and the execution of the diagnosis is suppressed. On the other hand, if it is determined that there is no abnormality, the processing proceeds to step S15 and the diagnosis processing is started.

For example, when one or more of conditions, which are that at least one port of the CA 105 of the CM 11 is not linked up, the synchronous copy processing by the CM 11 is not normally executed, the CM 11 is being restarted, and at least one piece of hardware error information acquired in step S12 indicates the occurrence of an error, are satisfied, it is determined that there is an abnormality in the CM 11 and the port diagnosis processing is ended.

As described later, in a case where a failover is instructed from the monitoring server 40, the diagnosis of the ports by the standby CM 21 is immediately interrupted, and the failover is preferentially executed. Thus, control is performed such that business operations in the business server 30 is not interrupted.

According to the processing in steps S11 to S14 described above, in a case where any abnormality occurs in the active CM 11, it is determined that there is a possibility of the occurrence of a failover and the execution of diagnosis is suppressed. In other words, the diagnosis of the ports is started only when it is determined that the possibility of the occurrence of a failover is low. Thus, the possibility of the occurrence of a failover during the diagnosis of the ports may be reduced.

In step S14, also in a case where it is determined that a hardware error of the CA 205 of the CM 21 has occurred from the information acquired in step S13, the port diagnosis processing is ended.

[Step S15] The CA control unit 221 updates the diagnosis flag 214 to “1”. Thus, the mode transitions to an operation mode in which the diagnosis of the CA 205 is being executed.

[Step S16] The CA control unit 221 switches the port identification numbers set for the ports 205a and the 205b of the CA 205 in the port setting table 211 to the diagnosis port identification number 212.

[Step S17] The CA control unit 221 executes a diagnosis processing loop up to step S24 for each of the ports 205a and 205b of the CA 205.

[Step S18] The CA control unit 221 opens a processing-target port of the CA 205. In this state, since the diagnosis port identification number set in the port setting table 211 is referred to, a state occurs in which the business server 30 is unable to access the logical unit LU #1.

[Step S19] The CA control unit 221 determines whether the port is linked up. If the port is linked up, the processing proceeds to step S20. If the port is not linked up, the processing proceeds to step S22.

[Step S20] For the link-up of the port, only coupling between the processing-target port and the port of the nearest switch (either the switch 51 or the switch 52) is checked. Thus, the CA control unit 221 diagnoses whether or not coupling between the processing-target port and the port of the business server 30 is possible.

For example, in a case where communication using an FC is performed with the business server 30, the CA control unit 221 checks whether the processing-target port is logged in from the business server 30. If the port is logged in, it is determined that the coupling is possible. In a case where communication using iSCSI is performed with the business server 30, the CA control unit 221 issues a ping command to the port of the business server 30 via the processing-target port. If a response to the ping command is successfully received, it is determined that the coupling is possible.

[Step S21] The CA control unit 221 determines whether the processing-target port and the port of the business server 30 are successfully coupled to each other. If the ports are successfully coupled to each other, the processing proceeds to step S23. If the ports are not successfully coupled to each other, the processing proceeds to step S22.

[Step S22] The CA control unit 221 records, in the storage unit 210, information indicating that an abnormality has occurred in the processing-target port. In step S22, the information indicating that an abnormality has occurred in the processing-target port may be transmitted to an administrator terminal (not illustrated) operated by an administrator, and the administrator may be notified of the occurrence of the port abnormality.

[Step S23] The CA control unit 221 closes the processing-target port of the CA 205.

[Step S24] After the processing of steps S18 to S23 is executed for each of the ports 205a and 205b of the CA 205, the diagnosis processing loop is ended and the port diagnosis processing is ended.

The diagnosis processing loop described above for each of the ports 205a and 205b may be executed in parallel. For example, in a case where login information is provided for each of the ports on the access paths, the CA control unit 221 is able to check with which access path the coupling is successfully established even if the ports 205a and 205b are simultaneously opened. Thus, the diagnosis processing loop described above may be executed in parallel.

[Step S25] The CA control unit 221 returns the port identification numbers set for the ports 205a and 205b of the CA 205 in the port setting table 211 from the diagnosis port identification number 212 to the setting values set before step S16 is executed. Thus, the port identification numbers corresponding to the ports 205a and 205b are reset to the same values as those of the ports 105a and 105b of the active-side CA, respectively.

[Step S26] The CA control unit 221 updates the diagnosis flag 214 to “0”. Thus, the operation mode in which the diagnosis of the CA 205 is being executed is canceled.

According to the above-described diagnosis processing illustrated in FIGS. 8 and 9, in a state in which the port identification numbers of the ports 205a and 205b are changed to the diagnosis port identification number 212, the ports 205a and 205b are opened and the states of the ports 205a and 205b are diagnosed. Thus, the business server 30 does not recognize the opened ports 205a and 205b as access destination ports for accessing the logical unit. Accordingly, the standby CM 21 may diagnose the states of the ports 205a and 205b while avoiding a situation in which the business server 30 detects an abnormality related to access processing to the logical unit and may not continue the access processing.

Even if the ports 205a and 205b are opened after the port identification numbers of the ports 205a and 205b are changed as described above, the logical unit LU #1, which is supposed to be invisible from the business server 30, may be visible from the business server 30. In this case, the business server 30 may issue a command (LU information acquisition command) for acquiring information on the newly visible logical unit LU #1. If the CM 21 returns information indicating the logical unit LU #1 in response to this LU information acquisition command, the business server 30 may recognize the logical unit LU #1 as a new logical unit and execute an unnecessary operation such as drive incorporation. The processing load of the business server 30 may become unnecessarily high due to the execution of such an unnecessary operation.

Accordingly, in a case where the LU information acquisition command as described above is issued from the business server 30, the CA control unit 221 transmits response data indicating that there is no valid logical unit. Thus, a camouflage is made such that there is no logical unit accessible by the business server 30. This response data is prepared in advance as the diagnosis response data 213 described above.

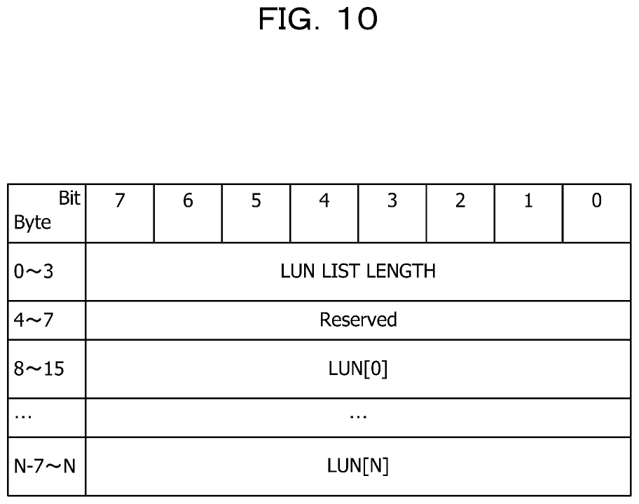

FIG. 10 is a diagram for describing a first example of the diagnosis response data. As an example of the LU information acquisition command described above, a REPORT LUNS command may be issued from the business server 30. The REPORT LUNS command is a SCSI command for acquiring the number of defined logical units and information on each logical unit.

FIG. 10 illustrates a format of response data to the REPORT LUNS command. This response data includes a LUN list length in which a value corresponding to the number of defined logical units is set, information on each logical unit, and the like. FIG. 10 illustrates information on each of the 0th to N-th logical units as LUN[0] to LUN[N].

When the REPORT LUNS command is received during the port diagnosis of the CA 205 (in a state in which the diagnosis flag 214=1), the CA control unit 221 sets “0” indicating that the logical unit is not defined as the LUN list length, and returns the response data without adding the information on the logical unit. For example, as the diagnosis response data 213 to the REPORT LUNS command, the response data in which “0” is set as the LUN list length and information on the logical unit is not added is stored.

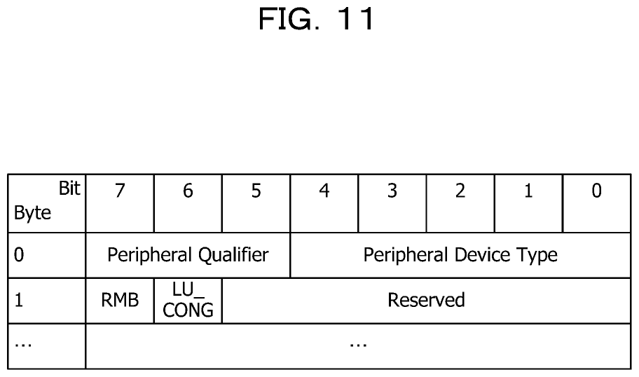

FIG. 11 is a diagram for describing a second example of the diagnosis response data. As an example of the LU information acquisition command described above, an INQUIRY command may be issued from the business server 30. The INQUIRY command is a SCSI command for acquiring the characteristics of a defined logical unit.

FIG. 11 illustrates a format of response data to the INQUIRY command. This response data include Peripheral Qualifier, Peripheral Device Type, and the like. The Peripheral Qualifier indicates the states of devices to which the logical unit is coupled. The Peripheral Device Type indicates the types of devices to which the logical unit is coupled.

When the INQUIRY command is received during the port diagnosis of the CA 205 (in a state in which the diagnosis flag 214=1), the CA control unit 221 returns response data in which “001b” is set as the Peripheral Qualifier and “1Fh” is set as the Peripheral Device Type. The former “001b” indicates that the designated logical unit has the capability of supporting the Peripheral Device Type but is not coupled at the present time. The latter “1Fh” indicates that there are no unknown devices or device types. Accordingly, as the diagnosis response data 213 to the INQUIRY command, the response data in which “001b” is set as the Peripheral Qualifier and “1Fh” is set as the Peripheral Device Type is stored.

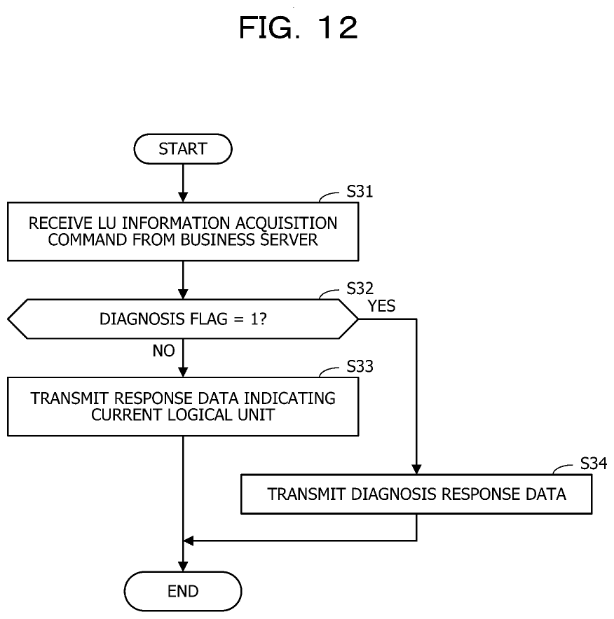

FIG. 12 is an example of a flowchart illustrating a procedure of LU information acquisition command reception processing.

[Step S31] When the CA control unit 221 of the CM 21 receives an LU information acquisition command from the business server 30, the processing in and after step S32 is executed.

[Step S32] The CA control unit 221 determines whether the diagnosis flag 214 is “1”. If the diagnosis flag 214 is “0”, for example, if the diagnosis of the port is not being executed, the processing proceeds to step S33. On the other hand, if the diagnosis flag 214 is “1”, for example, if the diagnosis of the port is being executed, the processing proceeds to step S34.

[Step S33] The CA control unit 221 transmits response data in which information on currently defined logical units (including information on the logical unit LU #1) is set, to the business server 30.

[Step S34] The CA control unit 221 reads the diagnosis response data 213 from the storage unit 210 and transmits the diagnosis response data 213 to the business server 30.

According to the processing in FIG. 12 described above, in a case where the diagnosis of the port is being executed in the standby CM 21, a response is made by using the diagnosis response data 213. Thus, the business server 30 determines that there is no logical unit accessible via the opened port. Therefore, the occurrence of a situation in which the business server 30 recognizes a new accessible logical unit, executes unnecessary processing accordingly, and the processing load becomes unnecessarily high may be avoided.

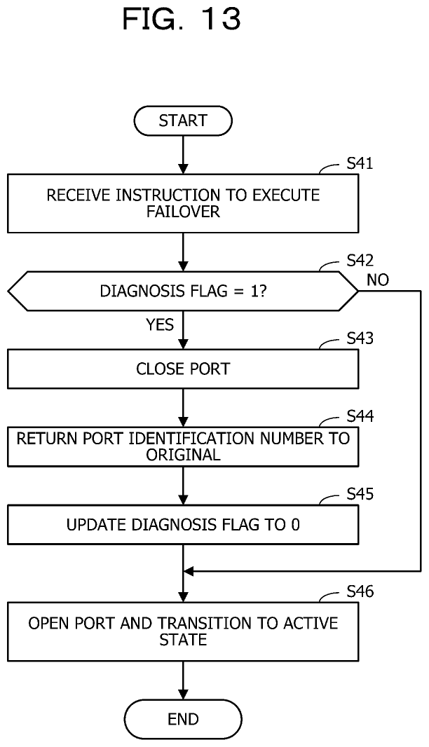

FIG. 13 is an example of a flowchart illustrating a procedure of failover processing.

[Step S41] In the monitoring server 40, when it is determined that the condition for executing a failover is satisfied based on the information collected by the information collection unit 41, the failover control unit 42 transmits an instruction to execute a failover to the standby CM 21. For example, when both of conditions 1 and 2 below are satisfied, the instruction to execute a failover is transmitted.

(Condition 1) The active CM 11 or the storage apparatus 10 is not alive, or the port(s) of the CA of the CM 11 is (are) not linked up.

(Condition 2) In the standby CM 21, the synchronous copy processing based on an instruction from the active CM 11 is stopped.

When the CA control unit 221 of the CM 21 receives the instruction to execute a failover from the monitoring server 40, the processing in and after step S42 are executed.

[Step S42] The CA control unit 221 determines whether the diagnosis flag 214 is “1”. If the diagnosis flag 214 is “1”, for example, if the diagnosis of the port is being executed, the processing proceeds to step S43. On the other hand, if the diagnosis flag 214 is “0”, for example, if the diagnosis of the port is not being executed, the processing proceeds to step S46.

[Step S43] The CA control unit 221 closes the port that is opened and is subjected to the diagnosis, and ends the diagnosis processing.

[Step S44] The CA control unit 221 returns the port identification numbers set for the ports 205a and 205b of the CA 205 in the port setting table 211 from the diagnosis port identification number 212 to the setting values set before step S16 is executed. Thus, the port identification numbers corresponding to the ports 205a and 205b are reset to the same values as those of the ports 105a and 105b of the active-side CA, respectively.

[Step S45] The CA control unit 221 updates the diagnosis flag 214 to “0”.

[Step S46] The CA control unit 221 opens the ports 205a and 205b of the CA 205, and causes the CM 21 to transition to an active state. Thus, the business server 30 accesses the logical unit LU #1 via the ports 205a and 205b.

According to the processing in FIG. 13 described above, in response to an instruction to execute a failover, the diagnosis processing of the ports is immediately ended and the failover is executed. Thus, even if a failover occurs during the diagnosis of the ports, the access processing from the business server 30 to the logical unit may be continued without any issue.

The processing functions of the apparatuses (for example, the storage apparatuses 1 and 2, the server 3, the CMs 11, 12, 21, and 22, the business server 30, and the monitoring server 40) described in each of the above embodiments may be implemented with a computer. In such a case, a program describing the details of the processing of the functions to be included in each apparatus is provided, and by executing the program with a computer, the above-described processing functions are implemented over the computer. The program describing the details of the processing may be recorded in a computer-readable recording medium. Examples of the computer-readable recording medium include a magnetic storage device, an optical disc, a semiconductor memory, and the like. Examples of the magnetic storage device include a hard disk drive (HDD), a magnetic tape, and the like. Examples of the optical disc include a compact disc (CD), a Digital Versatile Disc (DVD), a Blu-ray disc (BD, registered trademark), and the like.

When the program is distributed, for example, a portable-type recording medium such as a DVD or a CD on which the program is recorded is sold. The program may also be stored in a storage device of a server computer and be transferred from the server computer to an other computer via a network.

The computer that executes the program stores, in a storage device thereof, the program recorded on the portable-type recording medium or the program transferred from the server computer, for example. The computer reads the program from the storage device thereof and executes the processing according to the program. The computer may also read the program directly from the portable-type recording medium and execute the processing according to the program. Each time the program is transferred from the server computer coupled to the computer via the network, the computer may also sequentially execute the processing according to the received program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage apparatus comprising a controller, wherein
another storage apparatus including a first communication port is coupled to a network,
a first identification number with which a server accesses a first storage area via the first communication port is assigned to the first communication port, and
the other storage apparatus in an active state controls access to the first storage area in response to an access request received from the server via the first communication port,
the controller includes a processor that is configured to:
in a standby state,
close a second communication port in the storage apparatus, and
assign the first identification number to the second communication port as an identification number with which the server accesses, via the second communication port, a second storage area in which data is synchronized with data in the first storage area,
in a case where an operation of the other storage apparatus stops and the storage apparatus transitions to the active state,
control access to the second storage area by opening the second communication port and receiving the access request from the server via the second communication port, and
in a case where the diagnosis is executed when the storage apparatus is in the standby state, execute diagnosis of the second communication port by changing the first identification number assigned to the second communication port to a second identification number and opening the second communication port.

2. The storage apparatus according to claim 1, wherein
in a case where a command for acquiring information on a new storage area is received from the server in a state in which the second communication port is opened for the diagnosis, the processor is configured to return response data that indicates that a defined storage area does not exist to the server.

3. The storage apparatus according to claim 1, wherein
in a case where the operation of the other storage apparatus stops and a failover is instructed during execution of the diagnosis, the processor is configured to close the second communication port, change the second identification number assigned to the second communication port to the first identification number, and then cause the storage apparatus to transition to the active state and open the second communication port.

4. The storage apparatus according to claim 1, wherein
as the second identification number, an identification number that is not set for any communication port coupled to the network is set.

5. A control method for controlling a storage apparatus comprising a controller, wherein another storage apparatus including a first communication port is coupled to a network, a first identification number with which a server accesses a first storage area via the first communication port is assigned to the first communication port, and the other storage apparatus in an active state controls access to the first storage area in response to an access request received from the server via the first communication port,
wherein the control method comprising:
in a standby state,
closing a second communication port in the storage apparatus coupled to the server via the network, and
assigning the first identification number in the second communication port as an identification number with which the server accesses, via the second communication port, a second storage area in which data is synchronized with data in the first storage area, and
in a case where an operation of the other storage apparatus stops and the storage apparatus transitions to the active state,
controlling access to the second storage area by opening the second communication port and receiving the access request from the server via the second communication port and
in a case where the diagnosis is executed when the storage apparatus is in the standby state, executing diagnosis of the second communication port by changing the first identification number set for the second communication port to a second identification number and opening the second communication port.
